(19) United States
(12) Patent Application Publication
(10) Pub. No.: US 2007/0238913 A1
(43) Pub. Date: Oct. 11, 2007

(54) Energy generation process

(76) Inventors: Stephen L. Knupp, Wilmington, DE (US); John L. Knupp, Newark, DE (US)

Correspondence Address: HUNTLEY & ASSOCIATES, 1105 NORTH MARKET STREET, P.O. BOX 948, WILMINGTON, DE, 19899-0948, US

(21) Appl. No.: 11/212,184

(22) Filed: Aug. 26, 2005

(51) Int. Cl. A62D 3/00

(52) U.S. Cl. 588/406

(57) ABSTRACT

High temperature reaction of halogen-containing carbon, boron, silicon and nitrogen compounds with other compounds generates energy.

### BACKGROUND OF THE INVENTION

The development of explosives has been important in the history of civilization. The earliest explosives were deflagrating, beginning with black powder. Roger Bacon, in the thirteenth century, detailed the preparation of black powder. It was originally used in firearms, and not until the seventeenth century was it used in mines.

Detonating explosives were developed in the nineteenth century, based on the work of Alfred Nobel. Mr. Nobel succeeded in mixing nitroglycerin with an absorbent instead of a liquid which was difficult to handle and dangerous to transport. A solid substance, dynamite, was developed that was sensitive to the action of a blasting cap, but was relatively insensitive to ordinary shock.

Since the development of detonating explosives, continuing effort has been directed to maximize both the explosive force and the safety of explosive compositions and processes. Ammonium nitrate-fuel oil compositions have been effective explosives and safe to transport, but exhibited relatively modest detonating energy.

A wide variety of high energy reactions has been explored to discover means for generating a high heat of reaction and explosive energy. The known thermite reaction, in which iron oxide is reacted with aluminum to form iron and aluminum oxide, can generate a heat of reaction of about 0.94 kcal per gram and will reach a temperature of about 2200° C. In addition, it has been recognized that chemical compounds that are exposed to high temperatures will rapidly decompose. It has also been recognized that the reaction of polytetrafluoroethylene with aluminum under pressure generates about 3.16 kcal per gram.

Despite a wide variety of known high energy reactions, including those noted above, continued effort has been directed toward the development of explosive processes that will yield exceptional energy.

### SUMMARY OF THE INVENTION

The present invention is based on the discovery of a process that generates a heat of reaction that is many times greater than the explosive power of TNT (0.88 kcal/gram).

Specifically, the instant invention provides a process for generating energy by bringing together, with energy sufficient to break a halogen chemical bond,
(a) at least one halogen-containing component of the general formula RX₍ₙ₎ wherein R is a moiety containing at least one of carbon, boron, silicon and nitrogen; X is a halogen-containing moiety; and n is a positive integer, and
(b) at least one base component comprising at least one atom selected from Groups IA to VIA, transition metals, lanthanides and actinides of the Periodic Table of the Elements, excluding aluminum and aluminum oxide.

### DETAILED DESCRIPTION OF THE INVENTION

The instant invention is applicable to a wide variety of halogen-containing compounds of the general formula RX₍ₙ₎, wherein R is a moiety containing at least one of carbon, boron, silicon and nitrogen; X is a halogen-containing moiety; and n is a positive integer. The size of this component can vary widely, from monomeric compounds to complex polymers having thousands of repeating units. The composition of this component can also vary widely. The compounds include, for example, fluorocarbons and chlorofluorocarbons such as those typically used for solvents and refrigerants, polychlorinated biphenyls, chlorinated dioxins, as well as normally solid halogenated materials such as polyvinylchloride (PVC), polytetrafluoroethylene (PTFE) and perfluoropolyether. In the above formula, the present invention has been found to be particularly thermodynamically efficient with fluorine and chlorine-containing compounds. It has also been found to be particularly efficient in compounds in which R is carbon or boron, and those compounds are accordingly preferred. Those halogen-containing compounds in which R is carbon exhibit unusually high thermodynamic efficiency, and are accordingly especially preferred.

In accordance with the present invention, the halogen-containing compound is brought together with at least one base component as defined above. Elemental materials can be used as well as compounds thereof with anions or cations, and alloys, functional groups, substituent groups, ligands, complexes, free radicals, and chelates of these elements, excluding aluminum metal and aluminum oxide. Typical of such compounds are oxides, hydrides, nitrates, borates, amides, amines, chlorates, hydroxides, azides, and phosphates of the metal component. Of these, oxides, hydrides and nitrates have been found to be particularly convenient and effective, and are accordingly preferred. The particular application of the process will determine which specific halogen-containing component and which base component are the most effective. The toxicity and reactivity of the materials and their respective reaction products should be considered in the material selection of these components. The full thermodynamic and physical effects should be calculated when determining the materials, amounts, and conditions to be used.

In accordance with the present invention, the two components are brought together with energy sufficient to break the halogen bond or bonds in the halogen-containing compound. As will be evident to those skilled in the art, as with other chemical reactions, the amount of energy will vary with the specific compound selected, the temperature, amounts and purity of the components, the methods of preparation, the particle sizes and shapes, molecular weights, heat capacities, ambient conditions, and the method used to supply the energy. For example, the energy can be easily provided by the thermite reaction instead of heating by conventional means. The energy can be supplied in any convenient form, including heat, electricity (including, for example, static electricity, alternating current and direct current), electromagnetic radiation (including, for example, lasers and microwave radiation), atomic radiation, pressure, or other chemical reactions such as conventional explosives, primers or detonators. To minimize the production of undesired byproducts, the energy should be provided substantially instantaneously. The classic thermite reaction can be used to initiate the process. The thermite reaction provides the substantially instantaneous transfer of energy sufficient to break the halogen bond(s) in a localized area and initiate the process. However, less vigorous techniques for supplying the energy can be used by consideration of the specific compounds used and the other factors noted above. As will be evident to one skilled in the art, if insufficient energy is provided, the energy is not provided in an expedient fashion, or if the components are present in substantially non-stoichiometric amounts, the desired conversions may not be completed, and toxic compounds, including ones that may be in violation of various international treaties, may be produced. It is important to note that special safety precautions including, but not limited to, bunkers to contain possible blast effects, high airflow hoods (greater than 400 CFM) to ensure removal of toxic substances, and eye protection to protect the eyes from bright light and fragments should be considered when practicing the present process.

The order in which the halogen-containing component and the base component are brought together is not critical. The process can be operated by premixing and then adding energy, adding energy first and then mixing, or mixing and adding energy simultaneously. Partial pre-energizing and pre-mixing can also be used.

In one preferred embodiment of the present invention, the halogen-containing compound and the base metal component are present in substantially stoichiometric amounts. However, in another preferred embodiment, the process can be operated with excess halogen-containing reactant or binder such as perfluorosulfonic acid resin which, upon reaching its activation temperature, will generate fluorine based free radicals which can then be used for other purposes.

The process can also be operated with excess base metal components, which will result in the conversion of substantially all of the halogen-containing compounds to their respective metal halides.

The process can be carried out in multiple stages. For example, if C₄F₁₀ and boron hydride (B₁₀H₁₄) are used as the reactants and the reactants are surrounded by lithium hydride. Energy is added to the admixture of C₄F₁₀ and boron hydride by initiating a thermite reaction in the proximity to the admixture by bringing into contact iron oxide and aluminum metal in the presence of an initiator. The admixture reacts exothermically, generating about 3.25 kcal/gram of reactant. The products for this reaction are BF₃, CO₂, and H₂O. The BF₃ will then react exothermically with the lithium hydride in a secondary reaction, generating about 21.64 kcal/gram of lithium hydride reacted. The products for this reaction are LiF, B₂O₃, and H₂O.

The process can be used on a nanoparticle scale as well as the conventional macro and micro scales. The components do not have to be pure. In fact, in one specific application of the present invention, halogen contaminants can be removed from landfills and other contaminated sites.

The energy generated in the process of the present invention can be discarded or used in a wide variety of applications, including high explosives, incendiaries, rocket fuels, replacements for cartridges and propellants, making steam, fuel additives, corrosion applications, chemical reaction precursors, chemical reaction initiation, chemical recovery and destruction of halogen-containing moieties, chemical lasers, heaters, waste materials disposal, and a variety of weapons.

The present invention is further illustrated by the following specific examples, in which parts and percentages are by weight unless otherwise indicated.

### EXAMPLE 1

A reaction is carried out by admixing 74.2% perfluoroethane (C₂F₆) and 25.8% lithium hydride in air. Energy is added to the admixture by initiating a thermite reaction in the proximity to the admixture by bringing into contact iron oxide and aluminum metal in the presence of an initiator. The admixture reacts exothermically, generating about 6.5 kcal/gram of reactant. The products for this reaction are LiF, CO₂, and H₂O.

### EXAMPLE 2

The general procedure of Example 1 is repeated, except that perflouroethylene (C₂F₄) and magnesium oxide are used as the reactants. This reaction requires air. C₂F₄ is present in 56.3% of the mixture and magnesium oxide is present in 43.7% of the mixture. The admixture will react exothermically, generating about 1.48 kcal/gram of reactant. The products for this reaction are MgF₂ and CO₂.

### EXAMPLE 3

The general procedure of Example 1 is repeated, except that PTFE (polytetrafluoroethylene), calcium oxide, and calcium nitrate are used as the reactants. This reaction requires no air. The mixture is composed of 29.5% PTFE, 23.9% calcium oxide, and 46.6% calcium nitrate. The admixture will react exothermically, generating about 1.95 kcal/gram of reactant. The products for this reaction are CaF₂, CaO, N₂, CO₂, and H₂O.

### EXAMPLE 4

The general procedure of Example 1 is repeated, except that 1,2,4 trichlorobenzene (C₆H₃Cl₃) and calcium oxide are used as the reactants. This reaction requires air. The mixture is composed of 68.3% 1, 2, 4 trichlorobenzene and 31.7% calcium oxide. The admixture will react exothermically, generating about 2.68 kcal/gram of reactant. The products for this reaction are CaCl₂, CO₂, and H₂O.

### EXAMPLE 5

The general procedure of Example 1 is repeated, except that 2,4,6 tribromo-n-cresol (C₇H₅Br₃O) and calcium carbonate are used as the reactants. This reaction requires air. The mixture is composed of 69.7% 2,4,6 tribromo-n-cresol and 30.3% calcium carbonate. The admixture will react exothermically, generating about 1.86 kcal/gram of reactant. The products for this reaction are CaBr₂, CO₂, and H₂O.

### EXAMPLE 6

The general procedure of Example 1 is repeated, except that 2, 3, 5, 6 tetrachlorobenzoquinone (C₆Cl₄O₂) and calcium carbonate are used as the reactants. This reaction requires air. The mixture is composed of 36% 2, 3, 5, 6 tetrachlorobenzoquinone and 64% calcium carbonate. The admixture will react exothermically, generating about 1.55 kcal/gram of reactant. The products for this reaction are CaCl₂, CO₂, and H₂O.

### EXAMPLE 7

The general procedure of Example 1 is repeated, except that 2,2 dichlorobiphenyl (C₁₂H₈Cl₂, PCB 4) and calcium oxide are used as the reactants. This reaction requires air. The mixture is composed of 79.9% 2,2 dichlorobiphenyl and 20.1% calcium oxide. The admixture will react exothermically, generating about 5.1 kcal/gram of reactant. The products for this reaction are CaCl₂, CO₂, and H₂O.

### EXAMPLE 8

The general procedure of Example 1 is repeated, except that N₂F₄ and boron nitride are used as the reactants. This reaction requires no air. The mixture is composed of 75.9% N₂F₄ and 24.1% boron nitride. The admixture will react exothermically, generating about 2.13 kcal/gram of reactant. The products for this reaction are BF₃ and N₂.

### EXAMPLE 9

The general procedure of Example 1 is repeated, except that C₄F₁₀ and boron hydride (B₁₀H₁₄) are used as the reactants and the reactants are surrounded by lithium hydride. This reaction requires air. The mixture is composed of 85.4% C₄F₁₀ and 14.6% boron hydride. The admixture of C₄F₁₀ and boron hydride will react exothermically, generating about 3.25 kcal/gram of reactant. The products for this reaction are BF₃, CO₂, and H₂O. If a ratio of 74.1% BF₃ and 25.9% lithium hydride is used, the BF₃ will then react exothermically with the lithium hydride in a secondary reaction, generating about 21.64 kcal/gram of lithium hydride reacted. The products for this reaction are LiF, B₂O₃, and H₂O.

### EXAMPLE 10

The general procedure of Example 1 is repeated, except that 2 chlorodibenzo-p-dioxin (C₁₂H₇ClO₂) and calcium oxide are used as the reactants. This reaction requires air. The mixture is composed of 88.6% 2-chlorodibenzo-p-dioxin and 11.4% calcium oxide. The admixture will react exothermically, generating about 5.46 kcal/gram of reactant. The products for this reaction are CaCl₂, CO₂, and H₂O.

1. A process for generating energy by bringing together, with energy sufficient to break a halogen-chemical bond and generate free halogen radicals,
(a) at least one halogen-containing component of the general formula RX₍ₙ₎ wherein R is a moiety comprising at least one of carbon, boron, silicon and nitrogen; X is a halogen-containing moiety; and N is a positive integer; and
(b) at least one base component comprising at least one atom selected from Groups IA to VIA, transition metals, lanthanides and actinides of the Periodic Table of the Elements, excluding aluminum and aluminum oxide.

2. A process of claim 1 wherein X comprises fluorine.

3. A process of claim 1 wherein X comprises chlorine.

4. A process of claim 1 wherein component (a) is a fluorocarbon.

5. A process of claim 1 wherein component (a) is a chlorofluorocarbon.

6. A process of claim 1 wherein component (a) is a chlorocarbon.

7. A process of claim 1 wherein the halogen-containing component is present in a stoichiometric excess, and the resulting reaction products comprise halogen based free radicals and halides of the base component.

8. A process of claim 7 wherein X comprises fluorine and the resulting reaction products comprise fluorine based free radicals and fluorides of the base component.

9. A process of claim 7 wherein X comprises chlorine and the resulting reaction products comprise chlorine based free radicals and chlorides of the base component.

10. A process of claim 7 wherein component (a) is a fluorocarbon and the resulting reaction products comprise fluorine based free radicals and fluorides of the base component.

11. A process of claim 7 wherein component (a) is a chlorofluorocarbon and the resulting reaction products comprise fluorine based free radicals, chlorine based free radicals, and halides of the base component.

12. A process of claim 7 wherein component (a) is a chlorocarbon and the resulting reaction products comprise chlorine based free radicals and chlorides of the base component.

13. A process of claim 1 wherein the base component is present in a stoichiometric excess and the process results in the conversion of substantially all the halogen atoms into the halide of the base component.

14. A process of claim 13 wherein component (a) is a fluorine-containing compound and the process results in the conversion of substantially all the fluorine atoms into the fluoride of the base component.

15. A process of claim 13 wherein component (a) is a chlorine-containing compound and the process results in the conversion of substantially all the chlorine atoms into the chloride of the base component.

16. A process of claim 13 wherein component (a) is a fluorocarbon and the process results in the conversion of substantially all the fluorine atoms into the fluoride of the base component.

17. A process of claim 13 wherein component (a) is a chlorofluorocarbon and the process results in the conversion of substantially all the chlorine and fluorine atoms into the respective halides of the base component.

18. A process of claim 13 wherein component (a) comprises perfluorooctanoic acid and the process results in the conversion of substantially all the fluorine atoms in the perfluorooctanoic acid into the fluoride of the base component.

19. A process of claim 13 wherein component (a) comprises at least one polychlorinatedbiphenyl (PCB) and the process results in the conversion of substantially all the chlorine atoms in the PCB to the chloride of the base component.

20. A process of claim 13 wherein component (a) comprises at least one halogenated dioxin and the process results in the conversion of substantially all the halogen atoms in the dioxin into the halide of the base component.
